(19) United States
(12) Patent Application Publication
(10) Pub. No.: US 2016/0305642 A1
(43) Pub. Date: Oct. 20, 2016

(54) FLEXIBLE LED MODULE

(71) Applicant: TRUE STAR, INC., Daejeon (KR)

(72) Inventor: Wone-Hee CHOI, Daejeon (KR)

(21) Appl. No.: 14/706,056

(22) Filed: May 7, 2015

(30) Foreign Application Priority Data
Apr. 15, 2015 (KR) 10-2015-0053292

(51) Int. Cl. F21V 29/70; F21K 99/00

(52) U.S. Cl. CPC F21V 29/70; F21K 9/30; F21Y 2101/02; F21Y 2105/001

(57) ABSTRACT

Disclosed is a flexible liquid emitting diode (LED) module. The flexible LED module is improved for the dissipation characteristics of heat generated in a LED chip, and in addition, is separable to cut and use the desired LED chips according to output power of a lamp by arranging the LED chips in series or in parallel. In addition, the flexible LED module is applicable to various types of lamps because the flexible LED module is flexibly used according to the structures of the lamps.

This application claims priority to and the benefit of Korean Patent Application No. 2015-0053292, filed on Apr. 15, 2015, the disclosure of which is incorporated herein by reference in its entirety.

### BACKGROUND

1. Field of the Invention

The present invention relates to a light emitting diode (LED) module, and more particularly, to a flexible LED module in which the dissipation characteristics of heat generated in a LED chip is enhanced and the LED chips are arranged in series or in parallel so as to cut and use the desired LED chips according to output power of a lamp.

In addition, the present invention relates to a flexible LED module applicable to various shapes of lamps because the flexible LED module is flexible to be used according to the structures of the lamps.

2. Discussion of Related Art

Light emitting diode (LED) lamps are lighting devices using LEDs, which emit high brightness light using low power, and used for backlights of vehicles or various types of lighting devices, and have been in the spotlight as next generation lighting devices.

Since fluorescent lamps include a fluorescent material and have a problem in generating environmental pollution when the fluorescent lamps are discarded, the use of the fluorescent lamps has been restricted recently. Thus, LED lamps having the shapes of the fluorescent lamps have been developed.

An LED for the lamp is a type of a diode, and when a forward voltage is applied to the LED and electrons generated by electromagnetic induction move, light energy and thermal energy are generated from the energy of the electrons. At this time, since the two types of energy are inversely proportional to each other, the generation of a photon can be increased according to how fast heat generated in the LED is removed.

When an activation temperature of about 25 to 55° C. is maintained, the LED has characteristics in that light output and light efficiency thereof are maximized and the durability thereof can be maintained. That is, heat other than the proper amount of heat needed to activate electrons decreases the generation amount of the photons, and generates the excessive amount of current which reduces the bonding force of an atomic structure and damages the LED. This type of a heat problem mostly occurs when a high brightness and power LED for use in lighting is manufactured, and a design thereof to quickly dissipate heat other than the heat needed to activate electrons is needed.

In order to overcome the problem described above, various technologies have been developed, and three patent documents 1 to 3 are introduced as examples.

In most of the conventional LEDs, a package is designed to reduce the heat dissipation problem, and a high power LED manufactured using the package is commonly referred to as a power LED.

Generally a LED is formed with a LED chip or a LED package mounted on a printed circuit board (PCB). In the conventional LED, a current is input to a positive (+) electrode of a LED chip through a thin copper foil circuit layer of a PCB and output to a negative (−) electrode of the LED chip, and thus, light is emitted. At this time, since the thin copper foil circuit layer of the PCB cannot increase conductivity due to the limitation of the copper foil, an indirect heat dissipation method, in which heat of current resistance generated from the LED chip and circuit layer and heat simultaneously generated when photons are generated in the LED chip are transferred to a heat sink plate through an insulating layer of a lower part of the PCB so as to dissipate the heat, is used. Thus, the heat is not effectively dissipated compared to the amount of generated heat, and there is a limitation to implementing a power LED.

In addition, the conventional LED module for a lamp has a disadvantage in which it is not easy to control output power thereof because a plurality of LEDs are integrated on one substrate. That is, since the output power of the conventional LED module is already set, in order to manufacture a lamp having different output power, a LED module having desired output power should be manufactured additionally. Thus, the LED modules having various output powers should be manufactured according to the output powers of the LED lamps and there is disadvantage in that much time and many processes are needed to manufacture the LED modules.

In addition, since the conventional LED module is formed by mounting a plurality of LEDs on a rigid PCB, there is disadvantage in that lamps having various shapes cannot not be manufactured due to a lack of flexibility when the lamps are manufactured.

### PATENT DOCUMENTS

### 1. Korea Patent No. 0997172

### 2. Korea Patent No. 1060462

### 3. Korean Laid-open Patent Application No. 2011-0051071

### SUMMARY OF THE INVENTION

The present invention is directed to providing a flexible liquid emitting diode (LED) module capable of obtaining high power by improving the characteristic of heat dissipation, stabilizing a light source, and preventing a voltage drop at the same time.

In addition, the present invention is also directed to providing a flexible LED module in which the unit of a LED chip is repeatedly formed and the flexibility thereof is excellent to cut and flexibly use in various shapes according to the shapes or usages of lamps to be manufactured.

In addition, the present invention is also directed to providing a flexible LED module in which an electrode pattern configured to supply power to the LED chip serves as a heat sink plate so as to enhance the effect of heat dissipation and minimize power consumption and maintenance thereof is easy.

According to an aspect of the present invention, there is provided a flexible LED module, including: an electrode pattern made of a flexible material having conductivity; LED chips fixedly installed on a plurality of LED-chip-bonding-portions formed on the electrode pattern; and frames having LED-exposing-holes exposing the LED chips, and in the electrode pattern, feed lines are formed between the plurality of LED-chip-bonding-portions, and ground lines are formed at both sides of the LED-chip-bonding-portions, frame-coupling-bending-portions whose end portions facing the LED-chip-bonding-portions of the feed lines are bent toward a front surface of the electrode pattern and buried in the frames, and one or more frame-coupling-holes are formed in each of the frame-coupling-bending-portions and the LED-chip-bonding-portions to fix the frames by the frame-coupling-bending-portion and the frame-coupling-hole so that bottoms of the frames do not protrude from a rear surface of the electrode pattern and the electrode pattern is in surface-contact with a heat dissipation unit of a lamp to quickly dissipate heat.

A cut line may be formed across each of the feed lines and the ground lines and may allow a part of the flexible LED module to be cut according to necessity.

The LED chips may be connected to the adjacent LED chips in series or in parallel.

The frame may be made of a nonconductive material, and the electrode pattern and the frame may be coupled by an insert injection molding method.

The LED chip may be connected to the feed line and/or the ground line by wire-bonding.

The electrode pattern may be formed with a plurality of lines so that the plurality of flexible LED modules may be installed adjacent to each other, and connection portions may be formed so that portions being in contact with places on which the adjacent flexible LED modules are installed may be manufactured while being connected to each other during the manufacturing process and the portions may be separable after the process is completed.

Continuous-feed-lead-lines having traction holes or traction grooves may be formed at a regular interval through outer surfaces of both outermost LED modules of the plurality of lines of the LED modules so as to install the LED chips while pulling and moving the electrode pattern.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view of a flexible LED module according to an embodiment of the present invention;

FIG. 2 is an enlarged view illustrating a portion A of FIG. 1;

FIG. 3 is a perspective view of an electrode pattern included in a flexible LED module according to an embodiment of the present invention;

FIG. 4 is an enlarged view illustrating a portion B of FIG. 3;

FIG. 5 is a perspective view illustrating a part of a flexible LED module according to an embodiment of the present invention;

FIG. 6 is a plan view of the flexible LED module illustrated in FIG. 5;

FIG. 7 is a cross-sectional view taken along line C-C in FIG. 6;

FIG. 8 is an enlarged view illustrating a portion D of FIG. 7;

FIG. 9 is a plan view of a flexible LED module in which LED chips are connected in series according to an embodiment of the present invention;

FIG. 10 is a conceptual diagram illustrating a wiring state between the LED chips connected in series, in the flexible LED module in FIG. 9;

FIG. 11 is a plan view of a flexible LED module in which LED chips are connected in parallel according to an embodiment of the present invention;

FIG. 12 is a conceptual diagram illustrating a wiring state between the LED chips connected in parallel, in the flexible LED module in FIG. 11; and

FIG. 13 is a perspective view of any one LED chip portion separated from a flexible LED module.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

Like numbers refer to like elements throughout the description of the figures. In descriptions of the invention, when detailed descriptions of related well-known technology are deemed to unnecessarily obscure the gist of the invention, they will be omitted.

The present invention enhances the dissipation characteristics of heat generated in a liquid emitting diode (LED) chip, and the LED chips may also be arranged in series or in parallel to cut and use in any number required according to the output power of the lamp.

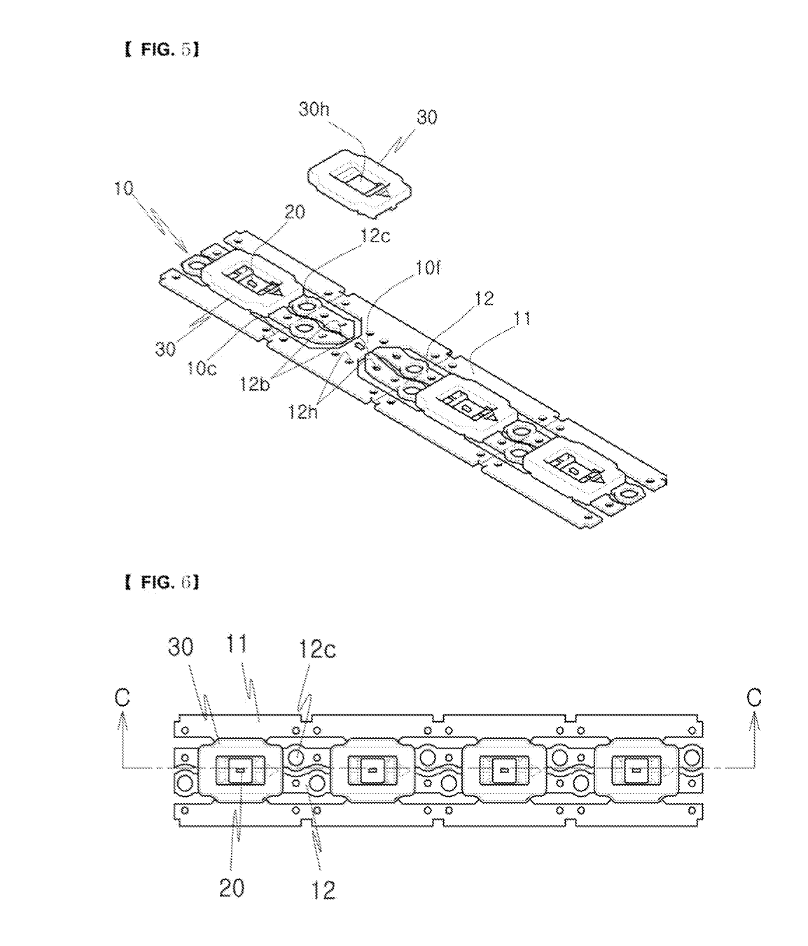

As illustrated in FIGS. 5 and 6, in a flexible LED module according to the embodiment of the present invention, a plurality of LED chips 20 are installed on a long belt-shaped flexible electrode pattern 10, and frames 30 are installed for each of the LED chips 20. That is, since the frames 30 are installed on each of the LED chips, respectively, and the electrode pattern is flexibly formed, the LED module may be flexibly used in a desired shape by bending the electrode pattern between the frames.

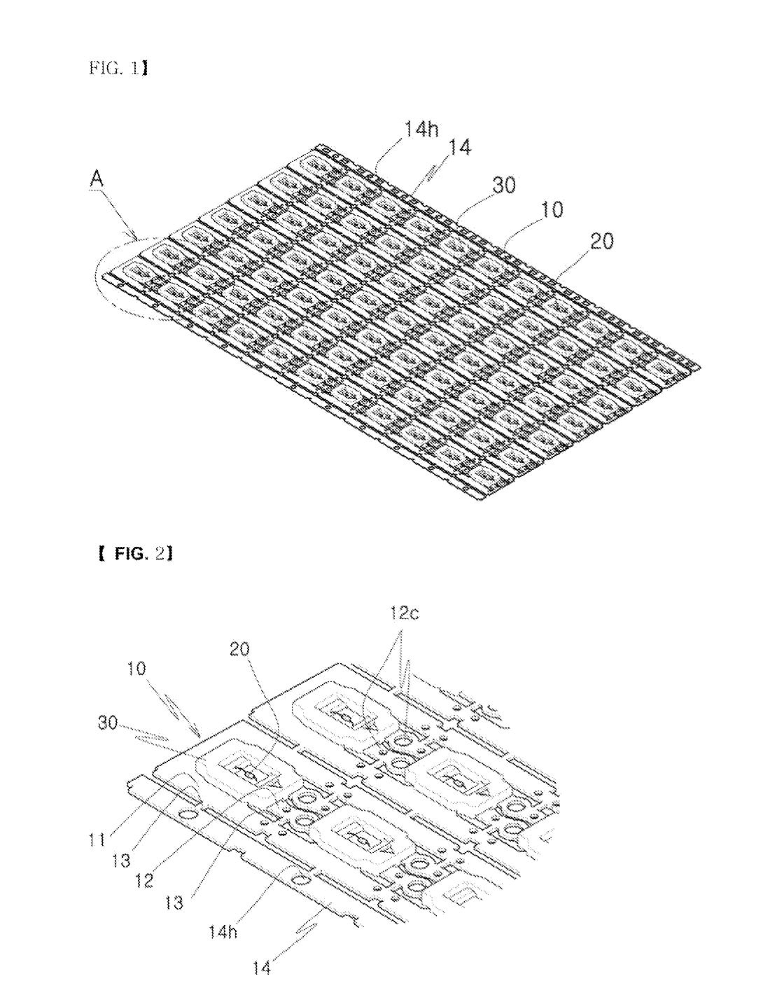

As illustrated in FIG. 1, a plurality of flexible LED modules may be assembled and manufactured on one electrode pattern 10 during a manufacturing process, to this end, as illustrated in FIG. 3, the electrode pattern 10 is formed with a plurality of lines so that the plurality of flexible LED modules may be installed adjacent to each other, connection portions 13 are formed so that portions being in contact with places on which the adjacent flexible LED modules are installed may be manufactured while being connected to each other during the manufacturing process and the portions may be separable after the process is completed, and continuous-feed-lead-lines 14 having traction holes or traction grooves may be formed at a regular interval in outer surfaces of both outermost LED modules of the plurality of lines of the LED modules and the LED chips may be installed by pulling and moving the electrode pattern.

That is, as illustrated in FIG. 3, the electrode pattern 10 is manufactured to form a plurality of lines of the LED modules and extend lengthwise in a longitudinal direction, and the LED chips are installed by pulling the continuous-feed-lead-lines 14 formed on the both outermost positions thereof in one direction by as much as a gap into which the LED chip 20 is installed.

As illustrated in FIG. 1, the manufactured LED modules as described above are in a state in which a plurality of lines of the LED modules are connected to each other, and the LED module having the LED chips 20 arranged in a line is manufactured by cutting the connection portions 13 located between the LED modules as illustrated in FIGS. 5 to 12.

Although FIG. 1 illustrates one embodiment in which one flexible LED module has 11 LED chips 20 and FIGS. 5 to 12 illustrate another embodiment in which one flexible LED module has four LED chips 20, various numbers of LED chips 20 may be installed thereon.

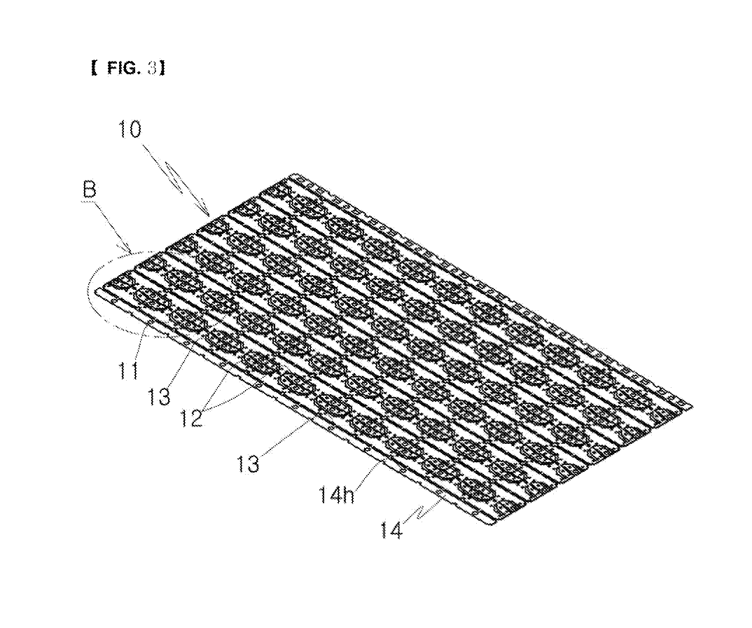

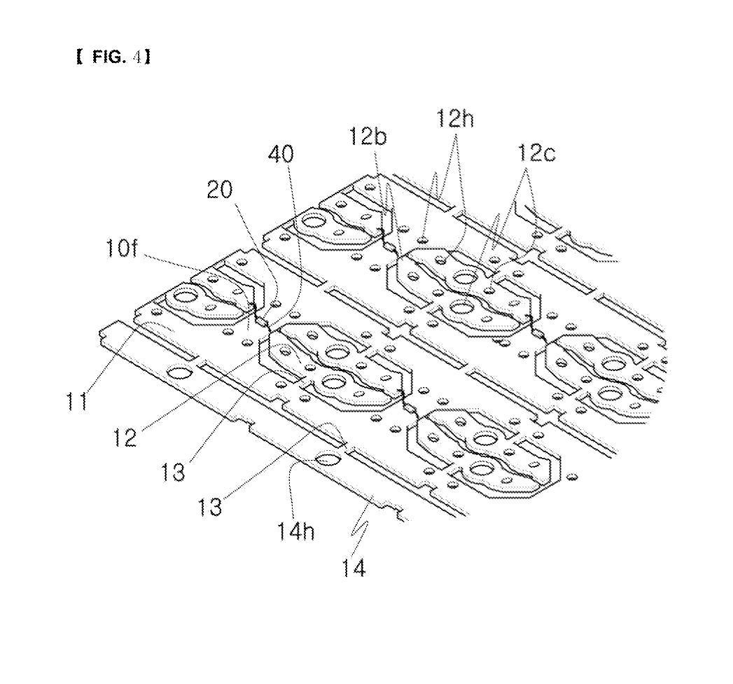

The electrode pattern 10 is made of a flexible metal which has excellent electrical conductivity and thermal conductivity, and as illustrated in FIGS. 3 and 4, feed lines 12 are formed between a plurality of LED-chip-bonding-portions 10f on which the LED chips are installed, and ground lines 11 are formed on the both sides of the LED-chip-bonding-portions 10f, and cut lines 10c are formed across the middle of the feed lines and the ground lines to cut the part thereof according to necessity.

That is, the electrode pattern 10 includes the ground lines 11 integrally and respectively connected to both sides of the plurality of LED-chip-bonding-portions 10f, has a ladder shape generally, and includes one or more of the feed lines 12 in spaces defined by the LED-chip-bonding-portions 10f and the ground lines 11.

In an enlarged view in FIG. 4, even when the feed line 12 is connected to the ground line 11 through the connection portion 13, the connection portion 13 will be cut when the LED module is completely made, and the feed line and the ground line will be electrically disconnected.

As described above, the LED module according to the embodiment of the present invention includes frames 30.

The frames 30 protect the LED chips, collect and emit light generated from the LED chips in a direction, and in addition, serve to reinforce the LED modules.

However, since the frames 30 are made of a rigid insulating resin, the LED module may have limited flexibility, and thus, the frames 30 of the present invention are separated and respectively installed on the individual LED chips. In addition, since the electrode pattern 10 of the present invention does not only simply supply power to the LED chip 20 but also serves as a heat sink plate configured to dissipate heat generated in the LED chip 20, it is preferable to quickly and effectively dissipate the heat absorbed into the electrode pattern 10.

Accordingly, it is preferable that the frame 30 cover only a minimum part of the electrode pattern 10. In addition, the electrode pattern 10 may enhance the heat dissipation efficiency by being in direct contact with a heat dissipation unit when the LED module 10 is installed in a lamp.

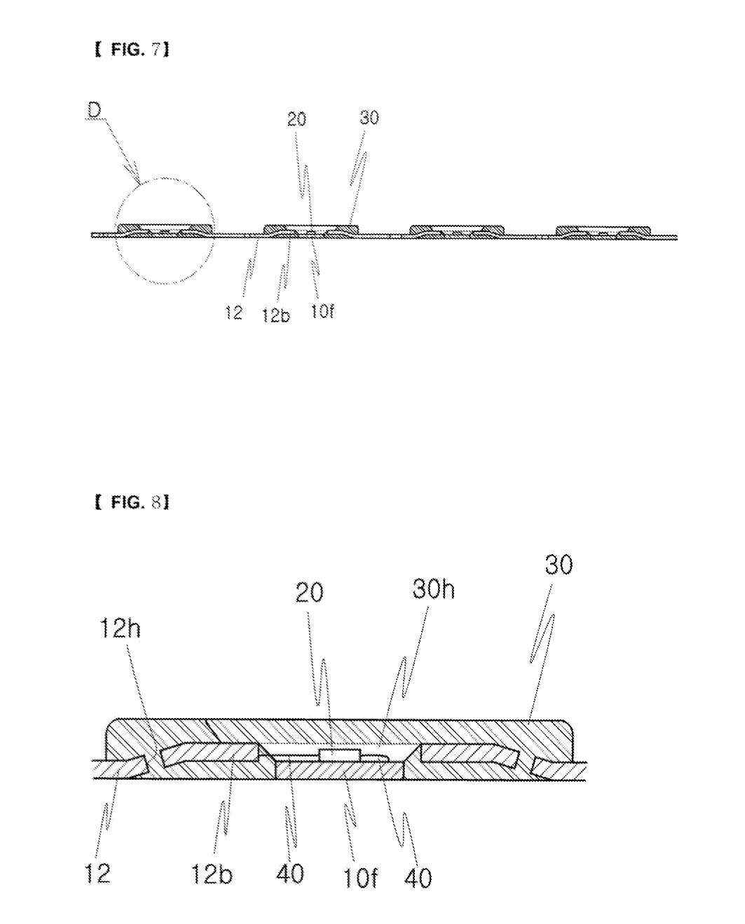

For the purpose described above, it is preferable that the frame 30 be installed to cover only a front surface of the electrode pattern 10 as illustrated in FIGS. 7 and 8. In order for the frame 30 to cover only the front surface of the electrode pattern, a fixing unit is needed to fix the frame 30 to a part of the electrode pattern, and the fixing unit is a frame-coupling-bending-portion 12b whose end portion facing the LED-chip-bonding-portion 10f of the feed line 12 is bent toward the front surface of the electrode pattern 10 and buried in the frame 30 as illustrated in FIGS. 4, 5, and 8.

As illustrated in FIG. 8, the frame-coupling-bending-portion 12b is buried in the frame 30 and holds the frame 30 to prevent separation from the electrode pattern.

In addition, one or more frame-coupling-holes 12h are formed in each of the frame-coupling-bending-portion 12b and the LED-chip-bonding-portion 10f, and a part of the frame 30 sinks into the frame-coupling-hole 12h and fills the frame-coupling-hole 12h to prevent uncoupling.

Thus, since the frame 30 is fixed to the electrode pattern by the frame-coupling-bending-portions 12b and the frame-coupling-holes 12h, a rear surface of the frame does not protrude from a rear surface of the electrode pattern, and the heat dissipation efficiency thereof is enhanced by the rear surface of the electrode pattern entirely being in surface-contact with a surface of the heat sink of a lamp.

However, even though the frame 30 is integrated with the electrode pattern by various methods, it is preferable to couple using an insert injection molding method. That is, after the electrode pattern is inserted in a frame forming process, the material of the frame is supplied, and thus, the electrode pattern is buried in the frame.

The flexible LED module configured as described above according to the embodiment of the present invention should include wiring configured to supply power to the LED chips 20.

However, even though various methods for the wiring may be used, it is preferable to connect the feed lines and/or the ground lines using wire-bonding.

In addition, as described above, in the flexible LED module according to the embodiment of the present invention, the number of LED chips may be selected, and the selected LED chips are cut and used to output the desired power, and in order for this, the LED chips 20 may be connected to adjacent LED chips 20 thereof in parallel and/or in series.

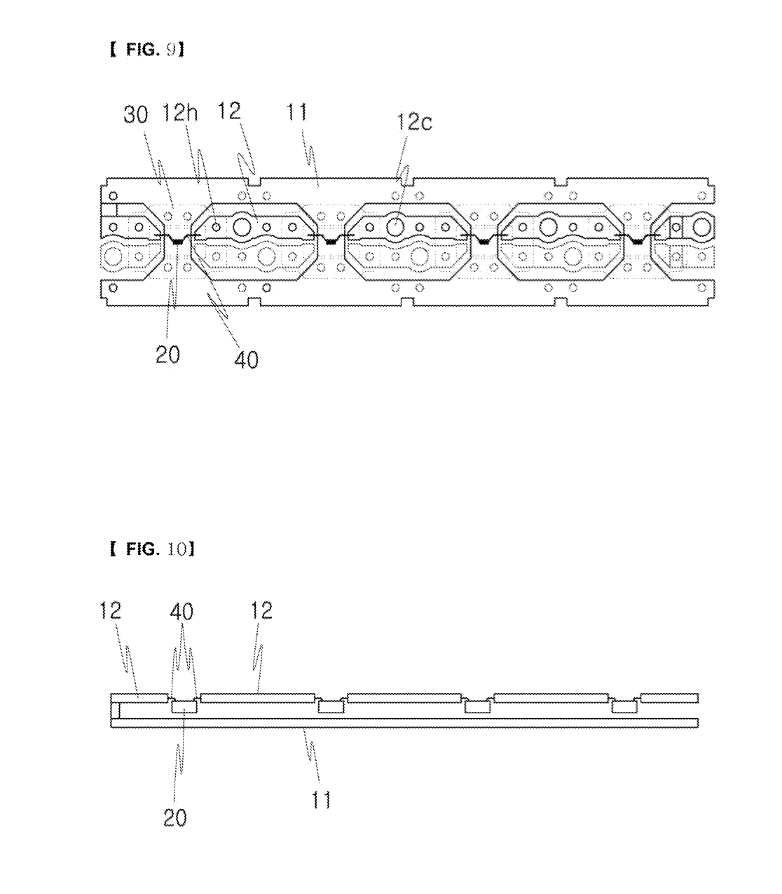

FIGS. 9 and 10 illustrate one embodiment in which the adjacent LED chips 20 are connected to each other in series. As illustrated, when both terminals of the LED chips 20 are respectively connected to the feed lines 12 at the both sides thereof so as to connect all of the LED chips 20 in series, and when an outermost feed terminal is connected to a ground terminal 11, the plurality of LED chips 20, the feed terminals, and the ground terminal configure a closed circuit to connect the LED chips in series as illustrated in FIG. 10.

Thus, when the desired number of LED chips 20 connected in series is selected, a lamp having the desired output power may be manufactured.

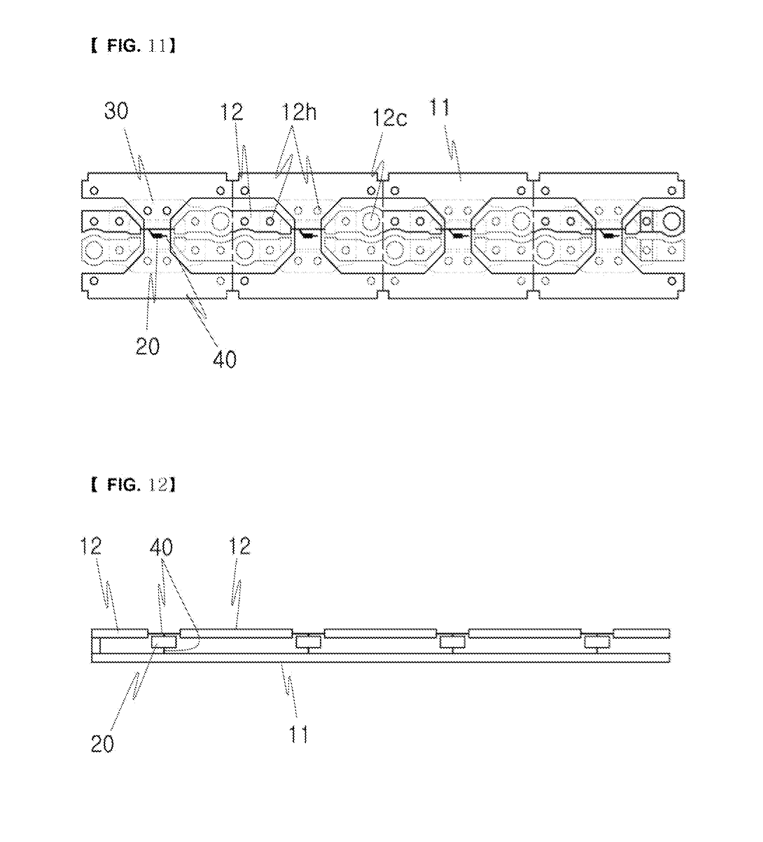

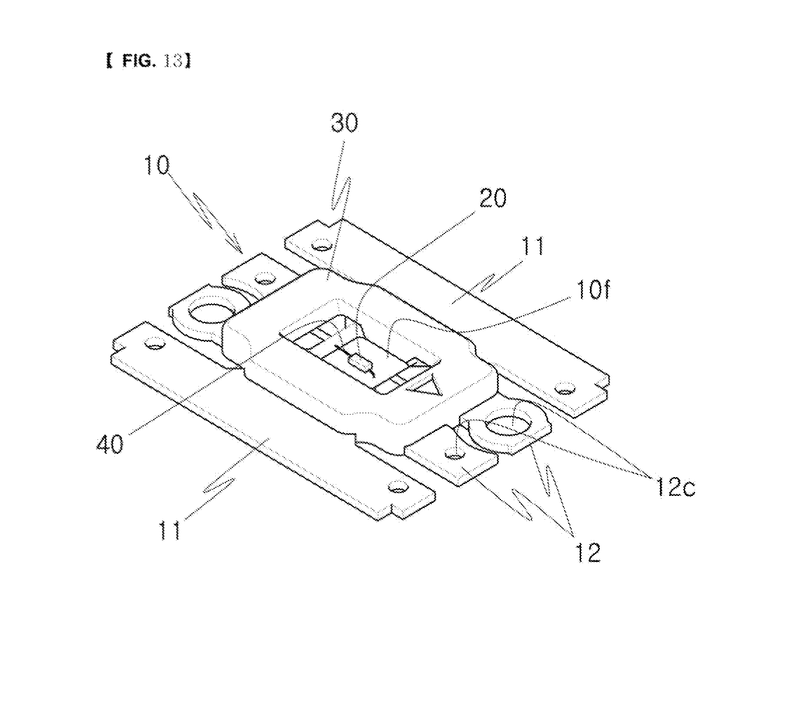

FIGS. 11 and 12 illustrate one embodiment in which the adjacent LED chips 20 are connected in parallel. As illustrated, when both terminals of the LED chips 20 are respectively connected to the feed lines 12 at the both sides thereof and one side terminal thereof is connected to the LED-chip-bonding-portion 10f, the plurality of LED chips 20 are connected in parallel between wirings of the feed terminal 12, a wire 40, and the feed terminal 12 and wiring of the ground terminal 11 as illustrated in FIG. 12.

Thus, when the desired number of LED chips 20 connected in parallel is selected, a lamp having the desired output power may be manufactured.

FIG. 13 is a perspective view of the LED chip separated from the flexible LED module having the plurality of LED chips. As illustrated, a very low output power lamp may be manufactured by cutting the cut line 10c of the LED module formed by an arrangement of the LED chips 20 connected in series or in parallel, and separating only one LED chip therefrom.

In addition, in the flexible LED module according to the embodiment of the present invention, connection holes 12c may be further formed in the feed lines 12. The connection holes 12c are holes to electrically connect electrical wires or the plurality of LED modules when a lamp is manufactured. In enlarged views in FIGS. 2 and 4, one side thereof is formed with a small diameter and the other side thereof is formed with a comparatively large diameter. A screw passing through a large diameter hole is tightened in a small diameter hole, and thus, two coupling parts may be coupled.

As described above, the flexible LED module according to the embodiment of the present invention has an effect in that the area of the electrode pattern where the LED chip is mounted is maximized, and thus, heat generated by a voltage drop and in LED chip can be dissipated in the shortest time.

In addition, the present invention has an advantage in that the cross-section area of an electrode is maximized and resistance thereof is minimized to make a flow of electrons flowing to the electrode pattern smoothly, and thus, the voltage drop can be minimized against the surface resistance generated from a surface of the LED chip by enhancing the flow of the electrons.

In addition, the present invention has another effect in that the electrode pattern is in direct contact with the LED chip in a wide area, and the cross-section area of the positive electrode of the LED chip is increased, and accordingly, thermal equilibrium between the LED chip and the positive electrode is quickly achieved, and thus, a problem in that the temperature of the active layer of the LED chip is sharply increased can be solved, the resistance of the LED chip is stabilized, and the current thereof is stabilized, and thus, constant current driving can be implemented easily when a convertor is designed.

In addition, the present invention still has another effect in that the virtual cut line is formed on the electrode pattern and the desired number of LED chips can be separated and the separated LED chips are individually used, and the plurality of the connection holes are formed in the electrode pattern between the plurality of the LED chips to connect two or more LED modules easily, and thus, a lamp having the desired output power according to necessity can be manufactured.

In addition, the present invention yet has another effect in that the LED module has the flexible electrode pattern and the separated frame is installed for each of the LED chips to have flexibility, and thus, lamps having various type of shapes can be manufactured due to a rollable and twistable LED module.

The above-described exemplary embodiments of the present invention are only examples and it will be understood by those skilled in the art that various modifications, alternations, and additions may be made without departing from the spirit and scope of the invention. Therefore, the modifications, alternations, and additions fall within the scope of the accompanying claims of the present invention.

What is claimed is:

1. A flexible liquid emitting diode (LED) module comprising:
an electrode pattern (10) made of a flexible material having conductivity;
LED chips (20) fixedly installed on a plurality of LED-chip-bonding-portions (10f) formed on the electrode pattern; and
frames (30) having LED-exposing-holes (30h) exposing the LED chips,
wherein, in the electrode pattern (10), feed lines (12) are formed between the plurality of LED-chip-bonding-portions (10f), ground lines (11) are formed at both sides of the LED-chip-bonding-portions (10f), frame-coupling-bending-portions (12b) whose end portions facing the LED-chip-bonding-portions (10f) of the feed lines (12) are bent toward a front surface of the electrode pattern (10) and buried in the frames (30) are formed, and one or more frame-coupling-holes (12h) are formed in each of the frame-coupling-bending-portions (12b) and the LED-chip-bonding-portions (10f) to fix the frames (30) by the frame-coupling-bending-portion (12b) and the frame-coupling-hole (12h) so that bottoms of the frames do not protrude from a rear surface of the electrode pattern (10) and the electrode pattern is in surface-contact with a heat dissipation unit of a lamp to quickly dissipate heat.

2. The flexible LED module of claim 1, wherein a virtual cut line (10c) is formed across a middle of each of the feed lines and the ground lines and allows a part of the flexible LED module to be cut according to necessity.

3. The flexible LED module of claim 1, wherein the LED chips (20) are connected to the adjacent LED chips (20) in parallel.

4. The flexible LED module of claim 1, wherein the LED chips (20) are connected to the adjacent LED chips (20) in series.

5. The flexible LED module of claim 1, wherein the frame (30) is made of a nonconductive material, and the electrode pattern and the frame are coupled by an insert injection molding method.

6. The flexible LED module of claim 1, wherein the LED chip (20) is connected to the feed line and/or the ground line by wire-bonding.

7. The flexible LED module of claim 1, wherein the electrode pattern (10) is formed with a plurality of lines so that the plurality of flexible LED modules are installed adjacent to each other, and connection portions (13) are formed so that portions being in contact with places on which the adjacent flexible LED modules are installed are manufactured while being connected to each other during the manufacturing process and the portions are separable after the process is completed, and continuous-feed-lead-lines (14) having traction holes or traction grooves are formed at a regular interval through outer surfaces of both outermost LED modules of the plurality of lines of the LED modules so as to install the LED chips while pulling and moving the electrode pattern.
